(19) United States
(12) Patent Application Publication
(10) Pub. No.: US 2020/0320490 A1
(43) Pub. Date: Oct. 8, 2020

(54) METHOD AND SYSTEM FOR CONDUCTING A TRANSACTION USING PRIVATE BLOCKCHAIN

(71) Applicants: Tet Hin Yeap, Ottawa (CA); Ci Lin, Ottawa (CA)

(72) Inventors: Tet Hin Yeap, Ottawa (CA); Ci Lin, Ottawa (CA)

(21) Appl. No.: 16/841,311

(22) Filed: Apr. 6, 2020

Related U.S. Application Data
(60) Provisional application No. 62/829,997, filed on Apr. 5, 2019.

(51) Int. Cl. G06Q 20/06; H04L 9/06; G06Q 20/38; G06Q 20/36

(52) U.S. Cl. CPC G06Q 20/0658; G06Q 20/3674; G06Q 20/3827; H04L 9/0637

(57) ABSTRACT

Methods and systems for representing a transaction using private blockchains are disclosed. In an example, a method for representing a transaction uses a private blockchain. The blockchain comprises a transaction block and a first sentinel block, the first sentinel block comprising a first previous hash field having an identical hash value as the first transaction hash field of the first transaction block, a first sentinel marker field for identifying the first sentinel block in the private blockchain, a first transaction data field containing a portion of the transactional information in the first transaction data field of the first transactional block, a first payload hash field comprising a hash value of the transaction data field of the sentinel block, and a first transactional hash field containing a first hash value of the first previous hash field and the first payload hash field; and appending the sentinel block to the transaction block.

### CROSS-REFERENCE TO RELATED APPLICATIONS

This application claims priority from U.S. Provisional Patent Application No. 62/829,997, filed Apr. 5, 2019, entitled BLOCKCHAIN WITH A SENTINEL, the contents of which are incorporated by reference herein.

### FIELD OF INVENTION

The present application generally relates to transactions using blockchain, in particular, to methods and systems for conducting a transaction using a private blockchain.

### BACKGROUND OF THE INVENTION

Vouchers are often provided by merchants in an effort to gain increased business from consumers by enticing a consumer to transact with the merchant for the very first time in the hopes that they will become a regular customer. Traditionally, vouchers have been sold to the public in places like Costco Wholesale. A consumer can buy a voucher at an amount less than the value of the voucher. The consumer brings the voucher to the merchant, and redeem it to gain the voucher's benefit. This is an inconvenient and expensive process because it involves printing, distributing and validating the vouchers generated.

Some systems have been developed that directly associate a voucher with a transaction account, to ensure that only the specified transaction account is eligible to redeem the coupon. However, this requires the merchant to store data regarding vouchers that are associated with transaction accounts, which can be resource-intensive and subject to data manipulation. In addition, the merchant must offer a suitable interface for the consumers to access the data storage to identify what vouchers have been associated with their transaction account.

A system for authentication of coupons using a blockchain was published in US2018150865 patent application. The system comprises: storing, in a memory of a point of sale device, transaction data for a payment transaction, wherein the transaction data includes at least a transaction amount; receiving, by a receiving device of the point of sale device, an identification value; receiving, by the receiving device of the point of sale device, a block included in a blockchain, wherein the block includes at least a block header and a plurality of transaction values, each transaction value including at least a coupon identifier and coupon data; executing, by a querying module of the point of sale device, a query on the received block to identify a specific transaction value of the plurality of transaction values where the included coupon identifier corresponds to the received identification value; and executing, by the querying module of the point of sale device, a query on the memory to update at least the transaction amount included in the stored transaction data based on the coupon data included in the identified specific transaction value.

A system for multiparty billing was published in U.S. Pat. No. 9,787,650 patent. One aspect of the invention provides a system for communicating originating network information for multiparty billing of network services, comprising; a network element for inserting into a service request an originating network attribute and an encrypted originating network attribute encrypted with the private-key of a private-public key pair of an originating network operator; a public-key server storing the respective public-key and providing access for public-key lookup to authorized parties; a network element for receiving a service request containing an originating network attribute and an encrypted originating attribute, extracting the originating network attribute, accessing the key server to look up the associated public-key, decrypting and verifying the originating network attribute, and forwarding of the service request for completion. The patent teaches us how to perform authentication of a billing services in multiparty scenario. It did not teach us how to keep track of billing in a multiparty scenario.

Thus, there is a need for a technological solution whereby vouchers can be issued by the merchant, can be bought by an individual and can be redeemed only by the individual or a party receiving the voucher from the individual, such as the individual's friend receiving the voucher. There is also a need for the system to rely on blockchain technology. As each transaction occurs, it is encoded into a new block of uniquely signed digital data. The newblock is then chained together with existing blocks creating an irreversible and immutable chain. As there is no consensus in privately held blockchains, a new type of blockchain is needed to protect the information in private blockchains.

### SUMMARY OF THE INVENTION

The present invention seeks to at least partially overcome or circumvent above-mentioned limitations of known voucher systems and methods, or at least provide an alternative.

The present invention describes a sentinel block for appending to the last block of a private blockchain. The sentinel block allows to detect any alteration of the blockchain and to determine the validity of the blockchain with the hash values of blockchains, include the hash value of the transaction hash of the sentinel block. The blockchain may be used to represent various transactions, including a voucher transaction, such as purchase, redemption of the voucher. The contents of any transaction may be included in the transaction date field of one or more blocks of the private blockchain.

In an aspect, the present invention also describes using a remote central depository to store the sentinel blocks of private blockchain or transaction hash value of the sentinel blocks of the private blockchains. The stored sentinel blocks of private blockchain or transaction hash value of the sentinel blocks of the private blockchains may be used to validate the private blockchains.

The invention relates to the system and method of a blockchain technology to provide incorruptible and verifiable data storage for the generation of vouchers by an enterprise, sale of vouchers to consumers and authentication of vouchers when it is presented to ensure redemption only by authorized individuals and immutability of voucher data. All transactions in the blockchain are protected by using a sentinel block at the end of each blockchain and central depository. In addition, the companies and consumers can download their respective blockchains for private storage and also validation of all the recorded transactions at any time.

In an aspect, all validated transactions may be permanently and immutably recorded in a private blockchain; even a system administrator cannot delete or alter a transaction. In addition, merchants and consumers can download their own blockchains for safe private storage, and also can validate all the recorded transactions offline.

The system and method may use blockchain technologies to keep track of all the transaction between service providers globally and regionally. As each transaction occurs, it is encoded into a block of uniquely signed digital data. The newly created block is then chained together with older blocks creating an irreversible and immutable chain.

As there is no consensus in privately held blockchains, a new method deploying a sentinel for each blockchain and a central depository for sentinel are needed to protect the information in the blockchains. As a result, all validated transactions can be permanently and immutably recorded; even a system administrator cannot delete or alter a transaction.

In addition, merchants and consumers can download their own private blockchains for safe private storage, and also can validate all the recorded transactions offline.

One aspect of the invention provides a system and method for protecting transactional information for multiparty exchange of transaction information, comprising: globally interconnected regional service providers so that they could mutually profit from related voucher sale transactions; merchants only need to setup accounts with their trusted local merchant service providers to sell vouchers online; consumers only need to setup accounts with their trusted local consumer service providers to buy vouchers online; vouchers can be issued by a merchant; vouchers can be bought by an individual and can be redeemed only by the individual or a party receiving the voucher from the individual, such as a friend of the individual.

During a transaction, the merchant service provider forwards the transaction amount to the corresponding consumer's service provider. The charges service provider charges the consumer by deducting the transaction amount directly from the consumer's account. Once the transaction amount is charged, the consumer service provider would pay the merchant service provider, which in turn would pay the corresponding merchant for vouchers rendered.

A clearing house is deployed to reduce the number of direct contractual relationships between regional service providers. In addition, a clearinghouse receives, validates and transfers billing records and/or performs financial clearing functions between regional service providers so that consumers of a regional service provider can pay online to corresponding merchants related to other regional service providers.

In an aspect, there is provided a method for conducting a transaction using a private blockchain, comprising: generating, by a processor, a first transaction block representing a first transaction in the private blockchain, the first transaction block comprising a first block header field, a first transaction data field containing first transactional information, a first payload hash field containing a first hash value of the transactional information, and a first transaction hash field containing a first hash value of a value contained in the first block header field and the first hash value contained in the first payload hash field; generating, by the processor, a first sentinel block, the first sentinel block comprising a first previous hash field having an identical hash value as the first transaction hash field of the first transaction, a first sentinel marker field for uniquely identifying the first sentinel block in the private blockchain, a first transaction data field containing at least a portion of the transactional information in the first transaction data field of the first transactional block, a first payload hash field comprising a hash value of the transaction data field of the sentinel block, and a first transactional hash field containing a first hash value of the first previous hash field and the first payload hash field of the first sentinel block; and appending, by the processor, the sentinel block to the transaction block of the private blockchain.

In an aspect, there is provided a system for conducting a transaction using a private blockchain, comprising: one or more service provider servers configured to communicate with each other; each service provider server comprising a processor and a memory; and the processor is configured to: receive, at the processor, a request to conduct a first transaction; in response, generate, by a processor, a first transaction block representing a first transaction in the private blockchain, the first transaction block comprising a first block header field, a first transaction data field containing first transactional information, a first payload hash field containing a first hash value of the transactional information, and a first transaction hash field containing a first hash value of a value contained in the first block header field and the first hash value contained in the first payload hash field; generate, by the processor, a first sentinel block, the first sentinel block comprising a first previous hash field having an identical hash value as the first transaction hash field of the first transaction, a first sentinel marker field for uniquely identifying the first sentinel block in the private blockchain, a first transaction data field containing at least a portion of the transactional information in the first transaction data field of the first transactional block, a first payload hash field comprising a hash value of the transaction data field of the sentinel block, and a first transaction hash field containing a first hash value of the first previous hash field and the first payload hash field of the first sentinel block; and append, by the processor, the first sentinel block to the transaction block of the private blockchain.

In an aspect, any one of the preceding methods, further comprises storing, by the processor, the private blockchain to a memory.

In an aspect, any one of the preceding methods further comprises storing, by the processor, the first sentinel block a remote central depository.

In an aspect, any one of the preceding methods, further comprises storing, by the processor, the first hash value of the first transaction has field of the first sentinel block to a remote central depository.

In an aspect, in any one of the preceding methods, wherein the transactional information includes a transaction amount and an identifier of the processor.

In an aspect, in any one of the preceding methods, the transactional information further includes one or more of a unique identifier of the transaction block in the private blockchain, and a description of the transaction.

In an aspect, in any one of the preceding methods, the first block header field contains a null value if the first transaction block is a first block of the private blockchain, and the first block header field contains a hash value of a transaction hash field of a block immediately preceding the first transaction block if the at least one block precedes the first transaction block.

In an aspect, in any one of the preceding methods, the first transaction is a voucher purchase from a merchant by a consumer.

In an aspect, any one of the preceding methods further comprises transmitting, from the processor, the private blockchain to an electronic device associated with a consumer.

In an aspect, any one of the preceding methods further comprises:
receiving, at the processor, the private blockchain from an electronic device associated with a consumer;
retrieving, by the processor, the first sentinel block corresponding to the private blockchain from the central depository; and
proceeding to a second transaction when the first transaction hash in the first sentinel block in the private blockchain is the same as the transaction hash in the first sentinel block saved in the central depository.

In an aspect, any one of the preceding methods further comprises:
receiving, at the processor, the private blockchain from the electronic device; identifying the first sentinel block from the private blockchain;
computing respective hash values of the first payload hash field of the first transaction block, the first transaction data hash field of the first transaction block, the first previous hash field of the first sentinel block, the first payload hash field of the first sentinel block, and the transaction data hash field of the sentinel block; and
validating the private blockchain, by the processor, when computed respective hash values are the same as the respective hash values in the first transaction block and the first sentinel block.

In an aspect, any one of the preceding methods further comprises: proceeding, by the processor, to a second transaction after the private blockchain has been validated.

In an aspect, any one of the preceding methods further comprises:
removing the first sentinel block from the private blockchain;
generating, by the processor, a second transaction block representing the second transaction, wherein the second transaction block comprising a second block header field comprising a hash value of the transaction hash field of the first transaction block, a second transaction data field containing transactional information of the second transaction, a second payload hash field containing a hash value of the transactional information of the second transaction, and a second transaction data hash field containing a hash value of a value contained in the second block header field and the hash value contained in the second payload hash field;
appending, by the processor, the second transaction block to the first transaction block;
generating, by the processor, a second sentinel block, the second sentinel block comprising a second previous hash field having an identical hash value as the second transaction hash field, a second sentinel marker field for uniquely identifying the second sentinel block in the private blockchain, a second transaction data field containing at least a portion of the transactional information in the transaction data field of the second transactional block, a second payload hash field comprising a hash value of the second transaction data field of the second sentinel block, and a second transactional hash field containing a hash value of the second previous hash field and the payload hash field; and
appending, by the processor, the second sentinel block to the second transaction block of the private blockchain.

In an aspect, in any one of the preceding methods, the second transaction is a voucher redemption.

In an aspect, any one of the preceding methods further comprises storing, by the processor, the second sentinel block or the second transaction hash of the second sentinel block to the remote memory.

In an aspect, any one of the preceding transaction system further comprises a remote central depository to communicate with the one or more service provider servers, wherein the remote central depository is configured to store the first sentinel block or the first transaction hash value of the first transaction hash field of the first sentinel block received from the processor.

In an aspect, any one of the preceding transaction system further comprises a communication network for the one or more service provider servers and the remote central depository to communicate with each other.

In an aspect, in any one of the preceding transaction system, the processor is configured to retrieve from the remote central depository stored first sentinel block or the first transaction hash value of the first transaction hash field of the first sentinel block.

In an aspect, in any one of the preceding transaction system, the processor is configured to execute any one of the preceding methods.

In an aspect, there is provide a non-transitory computer-readable medium containing instructions executable by a processor, the instructions configured to, when executed, cause the processor to execute the any one of the preceding methods.

In an aspect, the hash values in any one of the proceeding methods, systems, non-transitory computer-readable medium are determined by SHA-256, MD5, RIPEMD or WHIRLPOOL.

### BRIEF DESCRIPTION OF THE DRAWINGS

Reference will now be made, by way of example, to the accompanying drawings which show example embodiments of the present application, and in which:

FIG. 1 depicts an exemplary structure of a block used in a blockchain;

FIG. 2 depicts a schematic representation of a blockchain; and

FIG. 3 depicts an exemplary schematic representation of a blockchain with a sentinel and a depository for the sentinel, according to an embodiment of the invention;

FIGS. 4A and 4B depict examples of schematic representations of a blockchain with sentinel according to an embodiment of the invention;

FIG. 5 depicts a schematic representation of an exemplary system components involving a central depository to store the sentinel information of the blockchain according to an embodiment of the invention;

FIG. 6 depicts the organization of sentinel data storage in a depository server, according to an embodiment of the invention;

FIG. 7 depicts a schematic representation of an exemplary system components involved in a transaction, such as a voucher purchase request for multiparty billing according to an embodiment of the invention;

FIG. 8 depicts the flow of relevant transaction information for voucher purchase according to an embodiment of the invention;

FIGS. 9A and 9B depict schematic representations of exemplary blockchains with sentinel for multiparty voucher generation and sale according to an embodiment of the invention;

FIG. 10 depicts the flow of relevant transaction information for secure voucher redemption according to an embodiment of the invention;

FIG. 11 depicts a schematic representation of an exemplary blockchain with sentinel for multiparty voucher redemption according to an embodiment of the invention;

FIG. 12 depicts the organization of sentinel data storage in the database of a depository server for a blockchain in FIGS. 9A, 9B, and 11; and

FIG. 13 depicts the flow of relevant transaction information for payment clearance using a clearing house according to an embodiment of the invention.

Similar reference numerals may have been used in different figures to denote similar components.

### DETAILED DESCRIPTION OF EXAMPLE EMBODIMENTS

A blockchain is a growing list of records, called blocks, which are linked using cryptography. Each block contains a cryptographic hash of the previous block, a timestamp, and transaction data. The transaction data are generally represented as a linked list or a Merkle tree (also known as Hash tree). By design, a blockchain is resistant to modification of the data. A blockchain is an open, distributed ledger that can record transactions between two parties efficiently and in a verifiable and permanent way.

Blockchain technology can be used to keep track of transactions between parties, such as service providers, globally or regionally. As each transaction occurs, it is encoded into a block of uniquely signed digital data. The newly created block is then chained together with older blocks creating an irreversible and immutable chain.

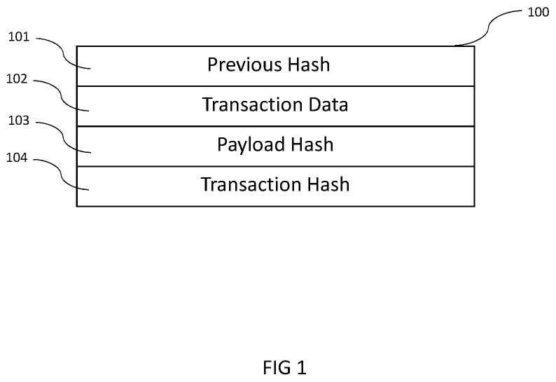

FIG. 1 shows the content of an exemplary block 100 for a transaction comprising previous hash field 101, transaction data field 102, payload hash field 103 and transaction hash field 104. A transaction data field 102 may comprise many sub-data fields such as date and time fields to include the information related to a transaction.

A hash is a one way mathematical function that maps data of an arbitrary size to a hash value of a fixed size. Many algorithms may be used to compute the hash value of data, for example, SHA-256, MD5, RIPEMD and WHIRLPOOL. The most popular hash algorithm is SHA-256. SHA-256 algorithm generates a fixed size 256-bit (32-byte) hash. The hash value of a piece of data cannot be decrypted back and is infeasible to invert. Therefore, once the hash of data is recorded, the data cannot be altered retroactively without alteration of the hash, thus protecting the data.

The previous hash field 101 in FIG. 1 contains the hash value of the previous block that immediately precedes the current block 100. The transaction data field 102 may contain data related to a transaction. The payload hash field 103 contains the hash value of the data content of the transaction data field 102. The transaction hash field 104 contains the hash value of previous hash 101 and payload hash 103.

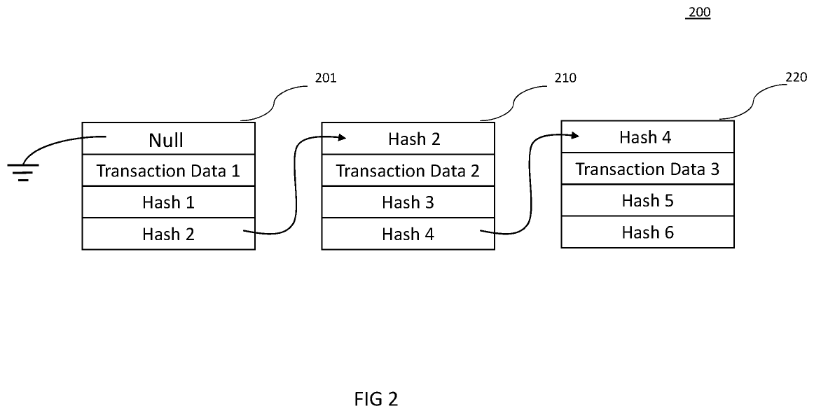

FIG. 2 depicts an exemplary blockchain 200. Blocks 201, 210 and 220 are chained together through the previous block field and the transaction block field in each block. The previous block field of each block with the exception of first block takes the hash value of the previous block's transaction hash field, thus forming the blockchain. The first block 200 in the chain is the block header and is not connected to any block. Therefore, the previous hash field contains a NULL.

The purpose of the payload hash field 103 is to protect the transaction data field 102. As described above, the transaction hash field 104 contains the hash value of previous hash 101 and payload hash 103. Therefore, transaction hash field 104 protects the transaction data of the current block and the transaction data of all previous blocks. If a previously published block was changed, transaction hash field 104 would have a different hash. This in turn would cause all subsequent blocks to also have different hash values since they include the hash of the previous block. Therefore, transaction hash field 104 makes it possible to easily detect and reject altered blocks.

For use as a distributed ledger, a public blockchain is typically managed by a peer-to-peer network collectively adhering to a consensus protocol such as Proof of Work Consensus Model for inter-node communication and validating new blocks. Once recorded, the data in any given block cannot be altered retroactively without alteration of all subsequent blocks, which requires consensus of the network majority. In some applications, it is more suitable to consider the use of private blockchain because the data generated and stored are not public but private. A private blockchain is permission based. A potential user cannot join a private blockchain unless the user is invited by the operator of the chain. Participant and validator access is restricted in a private blockchain.

However, as there is no consensus protocol in private blockchains, in the example of FIG. 2, the transaction information or transaction data 3 in the last block 220 of the blockchain may be easily altered without notice.

In some examples, to prevent the last block of a private blockchain from being altered, a sentinel block may be appended to the last block of a private blockchain to protect the information of the blocks, especially the information of the last block. A sentinel block may be used in a blockchain, such as a private blockchain as a traversal path terminator holding minimum reference of known data in the previous block.

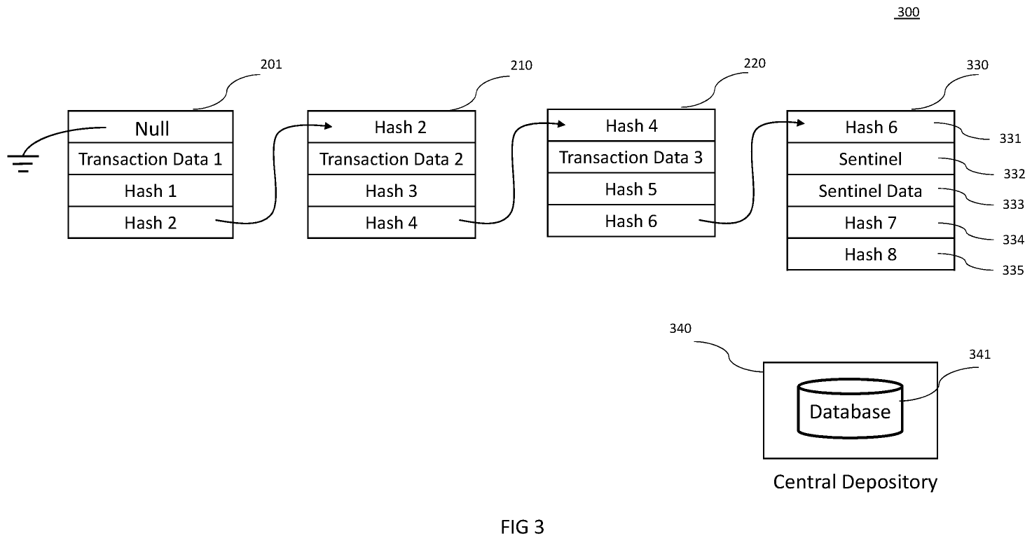

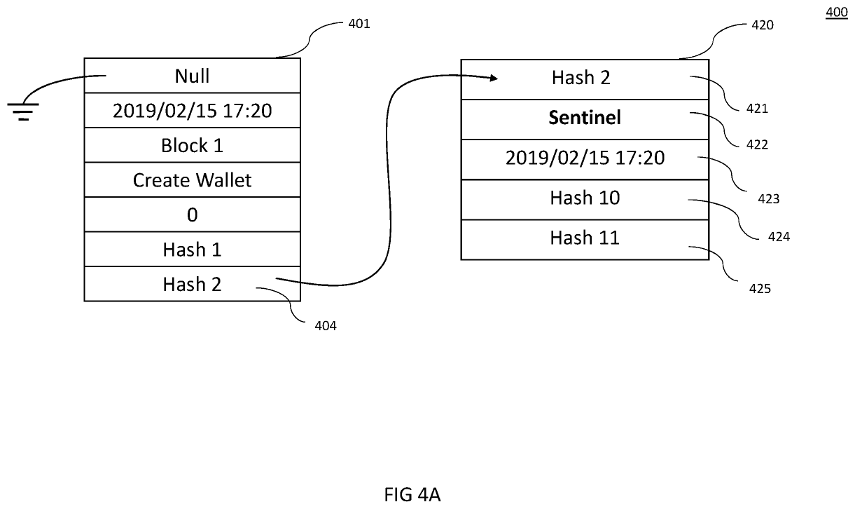

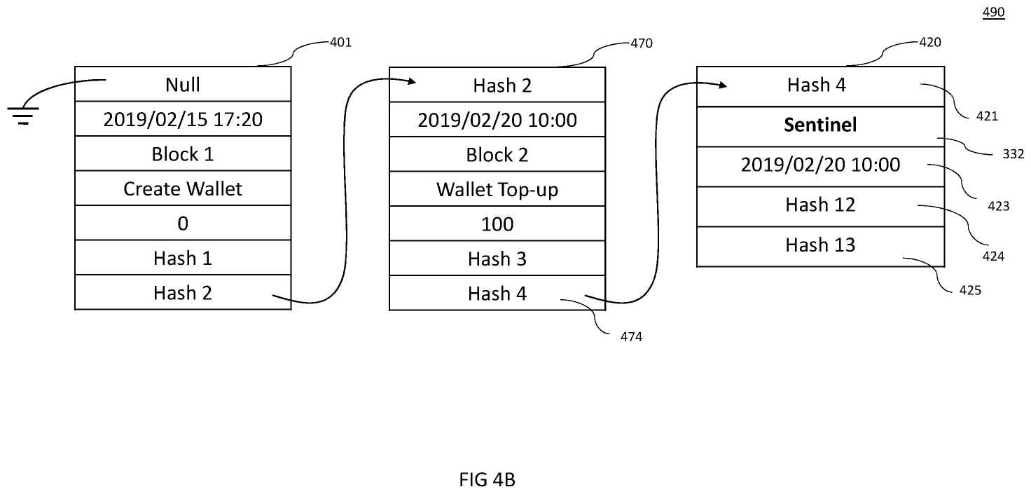

FIG. 3 depicts an exemplary blockchain 300, according to an embodiment of the present application. An exemplary structure of a sentinel block 330 is shown in FIG. 3. In this example, sentinel block 330 may be chained to the last block 220 of the blockchain 200 in FIG. 2. The content of a sentinel block may comprise a previous hash field 331, a sentinel marker field 332, a sentinel data field 333, a payload hash field 334 (Hash 7) and a transaction hash field 335 (Hash 8). The previous hash field 331 takes the transaction hash value of the last block in the blockchain, in this example, Hash 6. The sentinel marker field may contain a marker or an identifier to uniquely identify, for example, to a computer or server that the block 330 is a sentinel block in the blockchain 300. The sentinel data field 333 may include at least a portion of or entire contents of transaction data 102. The contents in the sentinel data field 333 may be used as an additional variable in generating the payload hash value in the payload hash field 334 and in the transaction hash field 335. In the example of FIG. 4A, the sentinel data field 333 includes the value of 2019/02/15 17:20, which is date and time value of the immediate proceeding block 401, as a portion of the transaction data in FIG. 4A. Alternatively or additionally, the sentinel data field 333 may also include the contents of “block 1” in block 401 as a portion of the transaction data of block 401.

Payload hash field 334 contains the hash value of the sentinel data included in the sentinel data field 333. The sentinel marker 332 does not participate in calculation of any hash value. Transaction hash field 335 contains the hash value of previous hash 331 and payload hash 334.

In the example of FIG. 3, if the previous published block 220 is changed, this in turn will cause the sentinel block 330 to also have different transaction hash value 335 since it includes the transaction hash 331 (hash 6) of the previous block 220. As such, the change in previous block 220 may be detected after the sentinel block 330 has been appended to the previous block 220 by comparing the hash values of hash 6 in block 220 and the sentinel block 330. Therefore, the sentinel block 330 may be used to protect the validity of all transaction data in the blockchain 300 because sentinel data in the transaction hash field 335 is based on the previous hash 331 and payload hash 334, which are related to the immediate preceding block 220. As such, all of the transaction data in all the blocks of blockchain 300 are protected by the sentinel block 330.

In some examples, in order to enhance the ability of the blockchain 300 to be more tamper evident and tamper resistant, the hash value of the transaction hash field 335 of the sentinel block 330 may be separately stored and locked in a database 341 of a central depository 340, as shown in FIG. 3. The central depository 340 may be a computer or a server that includes a processor and storage medium, such as non-transitory memory or hard disks. The hash value of the transaction hash field 335 stored in the central depository 340 may be used for further verification on the validity of the blockchain 300. For example, to verify the validity of all transactions in the blockchain 300, a computer or server may identify the sentinel block 330 by identifying the sentinel marker 332. After the sentinel block 330 is determine, the value of the transaction hash field 335 of the sentinel block 330 may be calculated or determined from the hash field 335. The computer may retrieve the stored hash value of the transaction hash field 335, and compare the calculated value of the transaction hash field 335 with the retrieved hash value of the transaction hash field 335. If both values are the same, the transactions in the blockchain 300 are valid. If both values are different, this indicates that the transactions have been changed after the hash value of the transaction hash field 335 has been stored in the central depository 340, and that the transactions in the blockchain 300 are invalid. In some examples, If the storage capacity of the central depository 340 allows, the central depository 340 may store complete information of the sentinel block 330, such as the entire block 330 in the database 341, for verifying the validity of the transactions protected by the sentinel block 330.

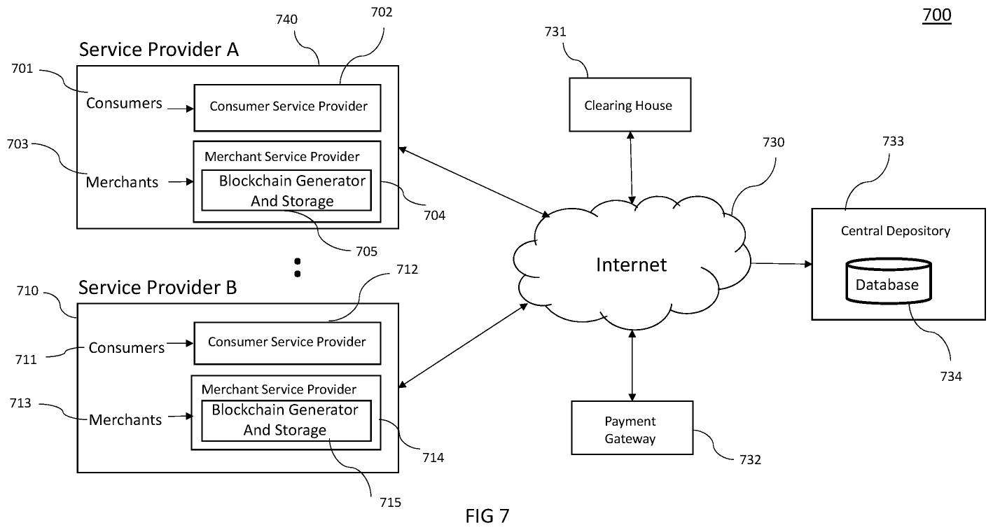

FIG. 4A is an example illustrating a blockchain 400 of a consumer in a transaction. In FIG. 4A, the blockchain record the transaction that a wallet or account of the consumer is created. In the example of FIG. 4A, a block 401 is generated by a computer or server, indicating the transaction of a wallet creation is shown in FIG. 4A. The transaction data in this example includes the fields “2019/02/15 17:20” to indicate the date and time when the block 401 is created, “Block 1” to indicate a block number assigned by a processor or a computer, such as the service provider server 710 or 740 in FIG. 7, to uniquely identify the block 401 in the blockchain 400, “create wallet” to indicate the type of the transaction, “0” to indicate the initial vale of in the account.

A sentinel block 420 may be appended to the block 401 to protect the transaction information in block 401. In the example of sentinel block 420, information of date and time information of the immediate preceding block 401 is used as the contents of the sentinel data field 333. The hash value of the previous hash field 421 of the sentinel block 420 takes the hash value (hash 2) of the transaction hash field 404 of the immediate preceding block 401. The payload hash field 424 takes the hash value (hash 10) of the date and time of the previous block 401 or the sentinel data field 423. Transaction hash field 425 takes the hash value (hash 11) of the previous hash 421 (hash 2) and the payload hash 424 (hash 10) in sentinel block 420.

FIG. 4B illustrates an exemplary state of blockchain 490 of the consumer when a top-up of 100 dollars occurred to the wallet or account of the consumer. When the consumer requests to add $100 into the account for example, from the user's bank account, a blockchain generator, such as a computer or server may generate a new block 470 indicating the top-up transaction of 100 dollars after the funds $100 has been transferred from the user, and insert the block 470 immediately follow the previous block 401. The new block 470 of the blockchain 490 show a running balance of 100 dollars in association with customer. Since block 470 is now the last block of the blockchain 490, the hash value of the previous hash field 421 (hash 4) of the sentinel block 420 is updated with the hash value of the transaction hash field 474 (hash 4). The payload hash field 424 is updated with the hash value of the sentinel data, such as date and time of the previous block 470, namely 2019/02/20 10:00. Transaction hash field 425 contains the hash value generated from hash of the previous hash 421 and the payload hash 424. The sentinel marker 332 may remain the same to identify the sentinel block 420.

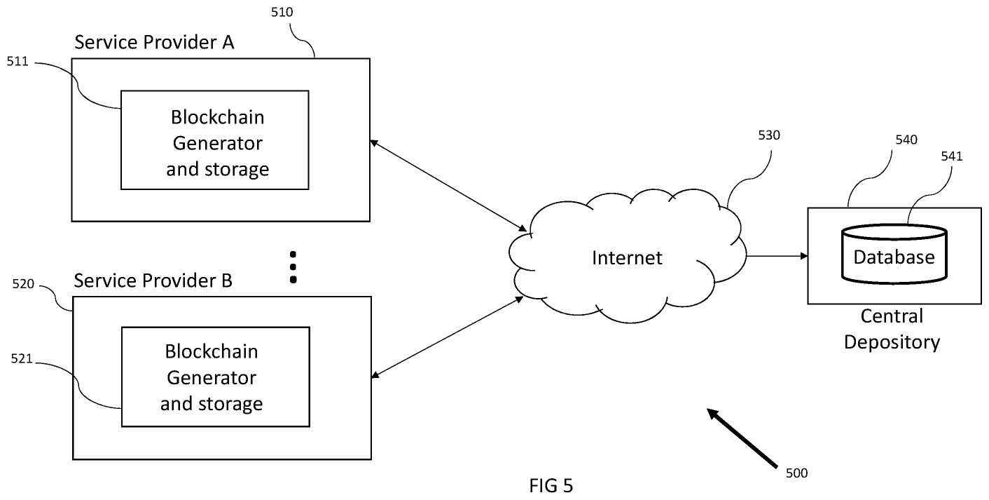

FIG. 5 is an exemplary system 500 that may be used for transactions with blockchains. The system 500 may include one or more blockchain generators and storage 510, 520 and one or more central depositories 540. The blockchain generators and storage 510, 520 and central depositories 540 may communicate with each other via a communication network 530, such as the Internet. The generator and storage 510, 520 may associate with respective service provider A and B. As each transaction occurs in the respective service providers 510, 520, blockchains may be created or updated in blockchain generator and storage 511 and 521 as described in the examples earlier. The blockchain generator and storage 511 and 521 may be one or more servers, workstations or computers, and may include a processor and a memory, including a non-transitory memory. The database 541, which is the same as the database 341 described in FIG. 3, in central depository 540, which is same as the central depository 340, is remotely connected to, through the Internet 530, and shared by blockchain generator and storage 511 and 521 of respective service providers 510, 520.

The blockchain generator and storage 511 and 521 may store the sentinel transaction hash 335, 423, or the sentinel block 330, 420 as described above via the communication network 530. The blockchain generator and storage 511 and 521 may also retrieve the sentinel transaction hash 335, 423, or the sentinel block 330, 420 via the communication network 530, for example, for verifying the validity of a transaction as described above. When a new block is generated and introduced in a blockchain by the blockchain generator and storage 511, 521, a sentinel block may be appended to the new block in the blockchain. The blockchain may be stored locally at the memory of the blockchain generator and storage 511 and 521. The blockchain generator and storage 511 and 521 may also store the information of sentinel, such as sentinel transaction hash 335, 425, or the sentinel block 330, 420 remotely in the central depository 540 as described above via the communication network 530. Once the information of the sentinel is store in the remote central depository 540, the information of the sentinel may be used to validate the blockchain, and the blockchain may become more tamper evident and tamper resistant.

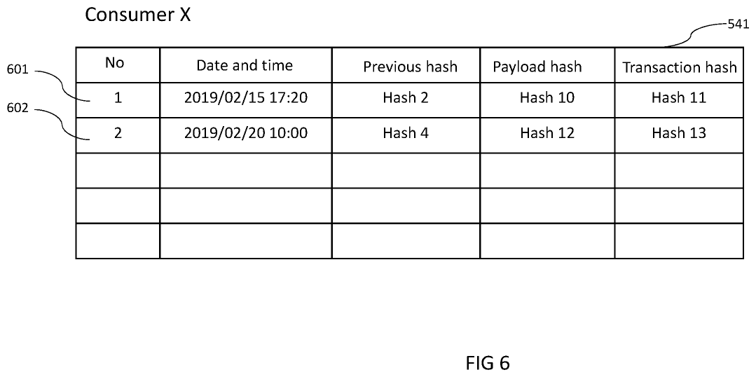

For example, for the blockchains 400 and 490 in FIG. 4A and FIG. 4B, the content of the database 541 in the central depository 540 for the blockchain 400 and 490 is shown in FIG. 6. The record 601 at row No. 1 shows the information of sentinel block 420 of FIG. 4A and record 602 at row No. 2 shows the information of sentinel block 420 of FIG. 4B. As mentioned above, the database 541 may also only include the transaction hash of the sentinel blocks. As a result, all validated transactions can be permanently and immutably recorded in the database 541 and the information of the sentinel block may be used to verify the validity of relevant transaction as describe above.

In some examples, the private blockchain method described above may be applied to provide, in a multiparty scenario, an incorruptible and verifiable method for transactions, including financial transactions. For example, a consumer X living in Germany is served by Deutch Telecom. A merchant Y in Canada is served by Bell Canada. It is desirable to have a multiparty system where consumer X can shop online for merchandise offered by merchant Y without having to open an account with merchant Y. Deutch Telecom may represent consumer X and Bell Canada may represent merchant Y that will perform the transaction via the private blockchain described above between the parties.

In some examples, the private blockchain descried above may also be used in transactions of generation of vouchers by an enterprise, sale of vouchers to consumers, and authentication of vouchers when it is presented to ensure redemption only by authorized individuals and immutability of voucher data. Each voucher transaction generated in a block by a blockchain generator of an enterprise may be a block of a private blockchain with a sentinel block attached to the block. The multiparty voucher generation, voucher sale and voucher redemption system 700, as shown in the example of FIG. 7, may comprise several servers interconnected by a communication network 730, such as the Internet: a Clearing House Server 731, a Payment Gateway Server 732 such as Paypal, a central depository 733, such as a server, for storing sentinel information of the sentinel block, and a plurality of consumer service provider server A 702, B 712 and merchant service provider servers 704, 714 owned by the respective service providers 740, 710. Consumer service providers 702 and 712 serve their respective consumers 701 and 711, while merchant service provider servers 704 and 714 serve their respective merchants 703 and 713. Consumers 701 and 711 can open their accounts with their respective consumer service providers 702 and 712. For example, consumer service provider servers 702 and 712 may create accounts for respective consumers 701 and 711. Each of consumers 701 and 711 can have his/her own wallet or account created with different virtual currencies and shopping cart. Merchants 703 and 713 may create their accounts at their respective merchant service provider servers 704 and 714. For example, merchant service provider servers 704 and 714 may create accounts for respective Merchants 703 and 713 so that each merchants 703 and 713 can have his/her own wallet with different virtual currencies and a voucher vault.

The regional service provider servers 740, 710 may be interconnected globally or regionally by the communication network 730 such as Internet so that regional service provider servers 740, 710 may provide business transactions between merchants and consumers. For example, the system 700 may allow merchants 703, 713 to create online stores or websites in respective merchant service provider servers 704, 714, to generate and store vouchers in their vaults, and to sell the vouchers to consumers interested in the vouchers. Consumers 701, 711 can browse merchant's website for vouchers and buy vouchers from merchants 703, 713 for their own consumption or can send as gifts to friend and relatives.

In this system 700 and method, merchants 703, 713 only need to sign single contracts with their respective trusted local merchant service providers 704, 714 to setup and manage merchants' websites. Once the websites are setup, merchants 703, 713 could generate vouchers and start selling vouchers online at the merchant's websites. With the contracts, the blockchain generator and storage 705 and 715 may generate a block in a blockchain for each transaction between the consumers and the merchant or for transactions between any parties, in the manners described in FIGS. 3, 4A and 4B.

Also in this system 700 and method, consumers 701, 711 only need to sign contracts with their respective trusted local consumer service providers 702, 712 to setup their accounts. When a consumer wants to shop for a voucher, the consumer may search, by browsing the merchant's website, for the voucher offered by a certain merchant locally or globally. Once the consumer finds the voucher of interest, the consumer service provider associated with the consumer may pay for the voucher on the consumer's behalf by deducting the respective amount from the consumer's account and deliver the voucher to the consumer.

In this example, with the consumer service provider, the consumer does not have to setup an account with any merchant 703, 713 in order to shop for a voucher and therefore improving the security of the consumer's information. In one scenario, consumers 701 registered under consumer service provider server 702 may shop for vouchers offered by local merchants 703 belonging to merchant service provider server 704. The selling of vouchers may be handled by the corresponding service provider server 704 with the blockchain generator and storage 705 using blockchain technology described above. Further examples in this regard will be described in the next few sections.

In another example, consumers 701 registered under consumer service provider server 702 may shop for vouchers offered by remote merchants 713 in association with merchant service provider server 714. The cross selling of vouchers from a merchant served by a service provider to a consumer served by another service provider is enabled by using the services provided by a Clearing House 731. Because of the cross sales of vouchers, merchants 703 or 713 may need to pay a transaction fee the parties involved when there is a successful sale.

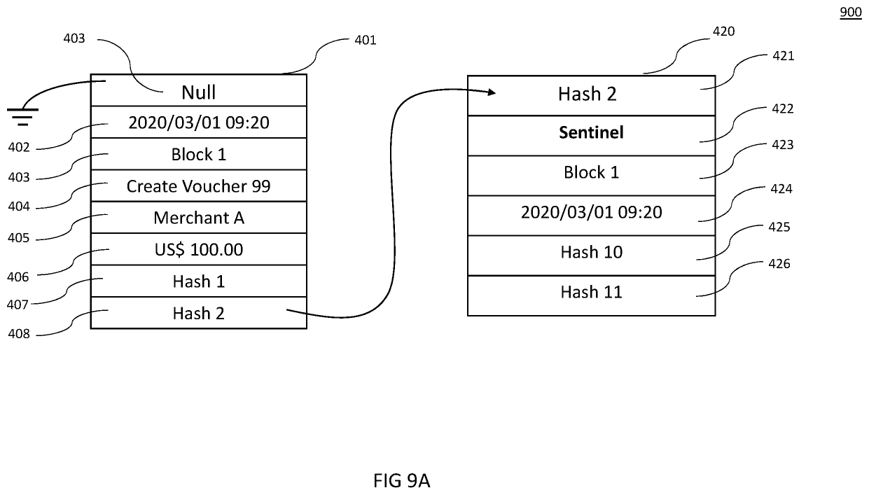

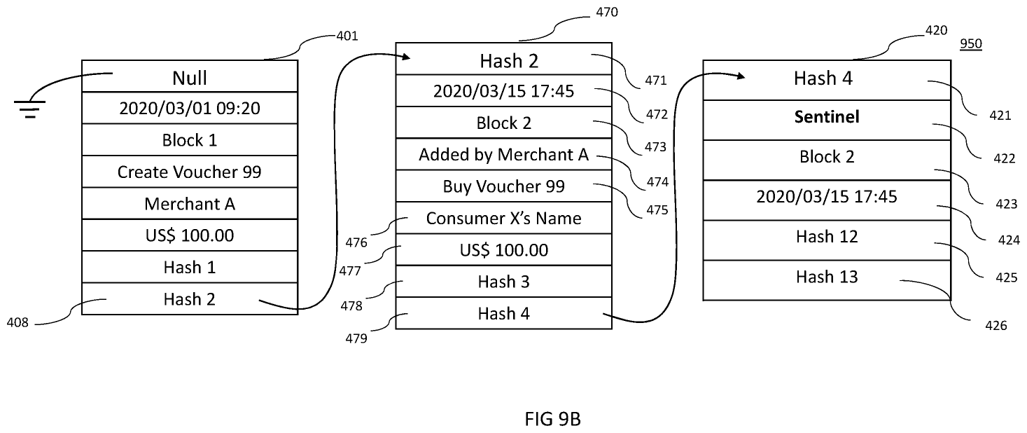

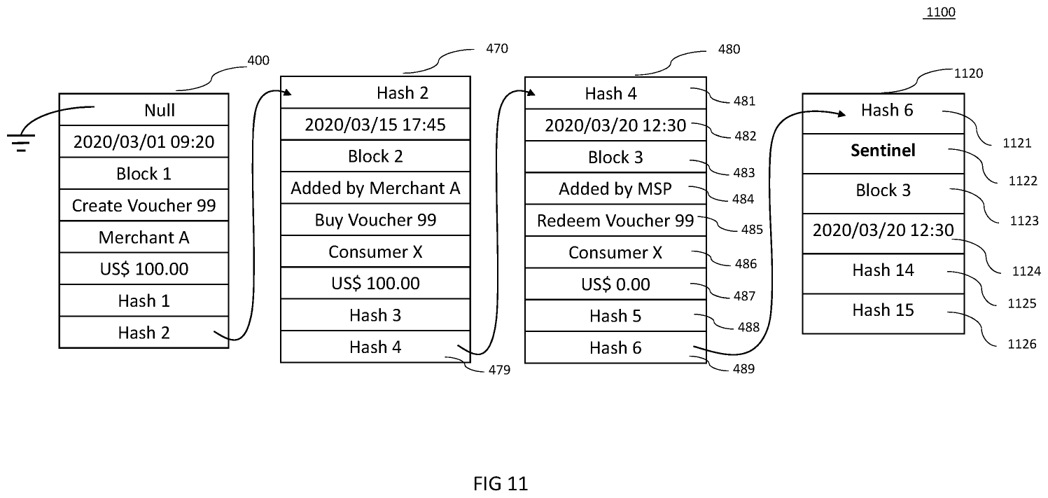

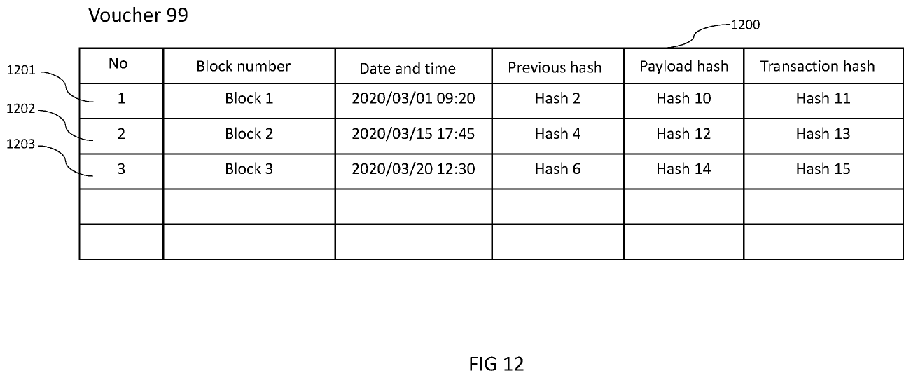

In order to enhance the blockchain to be tamper evident and tamper resistant, the information of a sentinel block of each blockchain for each transaction, such as the transaction hash of the sentinel block or the entire sentinel block described in FIGS. 3, 4A and 4B above, may be stored in the database 734 of the central depository 733, as shown in FIG. 7. For the blockchains in the examples of FIG. 9A, FIG. 9B, and FIG. 11 to be described below, the content of the database 734 in the central depository 733 for the blockchain related to voucher 99 is shown in FIG. 12. First row 1201 records the information the sentinel block 420 of FIG. 9A, second row 1202 records the information of sentinel block 420 of FIG. 9B, and third row 1203 records the information of sentinel block 420 of FIG. 11.

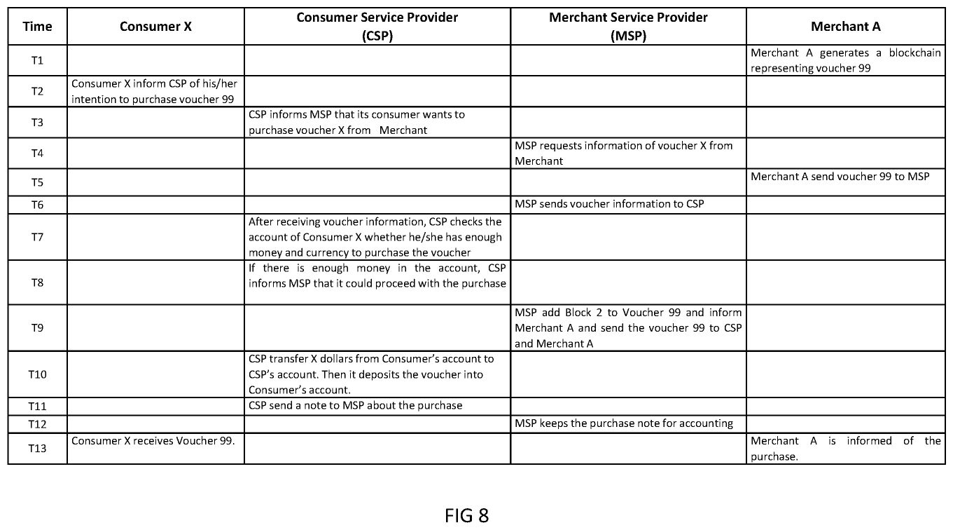

FIG. 8 is an exemplary flow chart illustrating an exemplary transaction process of voucher purchase. As depicted in FIG. 8 when the consumer service provider server 702 and merchant service provider server 704 are operated by the same service provider 740: At time step T1, using the blockchain generator and storage 705, 715, merchant A generates 100 vouchers and voucher 99 is one of the 100 vouchers using a predetermined format, for example, in the format of block 401 in FIG. 9A. In generating 100 vouchers, the blockchain generator and storage 705 may generate 100 blockchain blocks, representing the 100 vouchers, are generated.

FIG. 9A shows exemplary content of a blockchain 900 generated by the blockchain generator and storage 705 representing a voucher 99. The blockchain 900 includes a header block 401 and the sentinel block 420. The header block 401 shows that a voucher 99 is generated by merchant A with a value of $100.00 US dollars. Previous hash 401 is a NULL because the header block is the first block. Payload hash 407 (Hash 1) is the hash value of the data content in the transaction data blocks, namely date and time 402, block number 403, voucher operation 404, merchant name 405, and voucher value 406. For example, Hash 1=SHA-256 (2020/03/01 09:20, Block 1, Create Voucher 99, Merchant A, US$ 100.00). Transaction hash 408 (Hash 2) is the hash value of previous hash which is a NULL and payload hash 407, for example, Hash 2=SHA-256 (Null, Hash 1). The header block 401 of the voucher may be terminated by a sentinel Block 420. Previous hash 421 (Hash 2) in the sentinel block 420 is the transaction hash value 408 of the last block in the blockchain 900. Payload hash 425 (Hash 10) may be the hash value of the data content in the sentinel block, namely block number 423 and date and time 424 of the previous block 401. For example, Hash 10=SHA-256 (Block 1, 2020/03/01 09:20). In another example, the Payload hash 425 (Hash 10) may be the hash value include the sentinel marker 422, for example, Hash 10=SHA-256 (sentinel, Block 1, 2020/03/01 09:20).

In this example, block number 423 and date and time 424 are used as the known data in the previous block 401. Transaction hash 426 (Hash 11) is the hash value of previous hash 421 and payload hash 425, for example, Hash 11=SHA-256 (Hash 2, Hash 10).

At time step T2, consumer X 701 identifies a voucher (voucher 99) offered by merchant A 703 for example by browsing merchant A's website. At time step T2, consumer X 701 informs, for example via an electronic device of the consumer 701, consumer service provider server 702 of the intention to purchase voucher 99, for example by sending a request for voucher 99 from the electronic device of the consumer to a server of the services provider 702. The electronic device may communicate with other electronic devices, and the servers in system 700, such as receiving information from other devices or servers, and/or transmitting information to other devices or servers in system 700. The electronic device of the consumer may be a smart phone, a tablet, or a computer.

At time step T3, the consumer service provider server 702 receives the consumer request from the electronic device and informs merchant service provider server 704 that its consumer wants to purchase voucher 99 from the merchant A 703. At time step T4, the merchant service provider server 704 then requests information of voucher 99 from the merchant 703. At time step T5, the merchant A 703 sends the information of voucher 99 to merchant service provider server 704. At time step T6, the merchant service provider server 704 sends the information of voucher 99 to the consumer service provider 701. At time step T7, after receiving the information of the voucher 99 from the merchant service provider server 704, the consumer service provider server 702 may verify the account of consumer X 701 whether consumer X has sufficient funds to purchase voucher 99. At time step T8, after the consumer service provider server 702 determines that consumer X 701 has sufficient funds to purchase the voucher 99, the consumer service provider server 702 informs the merchant service provider server 704 that the merchant service provider server 704 may proceed with the purchase of voucher 99. In this case, the blockchain generator and storage 705 of the merchant A 703 may insert a second block 470 to the blockchain representing voucher 99 immediately following the block 401, as shown in the example of FIG. 9B, indicating that consumer X has bought voucher 99. Previous hash 471 of the block 470 is the transaction hash value 408 of the last block 401 in the blockchain 950, for example, Hash 2=SHA-256 (Null, Hash 1). Payload hash 478 is the hash value of the data content in the block namely date and time 472, block number 473, block operation 474, voucher operation 475, consumer X's name 476 and voucher value 477, for example, Hash 3=SHA-256 (2020/03/15 17:45, Block 2, Added by merchant A, Buy Voucher 99, Consumer X Name, US$100.00). Block number 473 may be a unique serial number assigned by the blockchain generator and storage 705. Transaction hash 479 (Hash 4 in FIG. 9B) is the hash value of previous hash 471 and payload hash 478, for example Hash 4=SHA-256 (Hash 2, Hash 3).

The blockchain of the voucher is terminated by a sentinel block 420. The sentinel block 420 may include previous hash 421, Sentinel Marker 422, sentinel data field, payload hash 425, and transaction hash 426. In the example of FIG. 9B, Sentinel Marker 422 is a field for identifying that the block 420 is a sentinel block, for example by including a string of bits exclusively reserved for the sentinel block; the sentinel data field may include a plurality sub-field, including the sub-field 423 with the value of the block number of the immediately preceding block 470 and sub-field 424 with the value of date and time 472. Previous hash 421 (Hash 4 in FIG. 9B) is the transaction hash value 479 of the last block in the blockchain as described above. Payload hash 425 (Hash 12) is the hash value of the data content in the sentinel block namely block number 423 and date and time 424 of the previous block, for example, Hash 12=SHA-256 (Sentinel, Block 2, 2020/03/15 17:45). Transaction hash 426 (Hash 13) is the hash value of previous hash 421 and payload hash 425, for example, Hash 13=SHA-256 (Hash 4, Hash 12).

At time step T9, the merchant service provider server 704 may then copy voucher 99 represented in blockchain 950 from the merchant voucher vault and send the voucher or blockchain 950 to the consumer service provider server 702. At time step T10, the consumer service provider server 702 transfers the cost of buying voucher such as $100 US dollars from the consumer 701's account registered with the consumer service provider server 702 to the consumer service provider's account and then deposits the voucher 99 in the form of blockchain 950 into the consumer 701's account and may save the blockchain 950 in the memory of the consumer service provider server 702. In some examples, the consumer service provider server 702 may also deposits the voucher 99 in the form of blockchain 950 into the electronic device associated with the consumer 701. The electronic device may save the blockchain 950 in the memory of the electronic device. At time step T11, the consumer service provider server 702 may notify, for example in a message, the merchant service provider server 704 that the voucher has been purchased by the consumer. At time step T12, the merchant service provider server 704 keeps the message of the purchase note for accounting later. At time step T13, the voucher 99 is ready for use by consumer X 701 and merchant A 703 is informed of the purchase of the voucher by the consumer. The consumer 701 may visit the website of Merchant A 703 to redeem the voucher in the future.

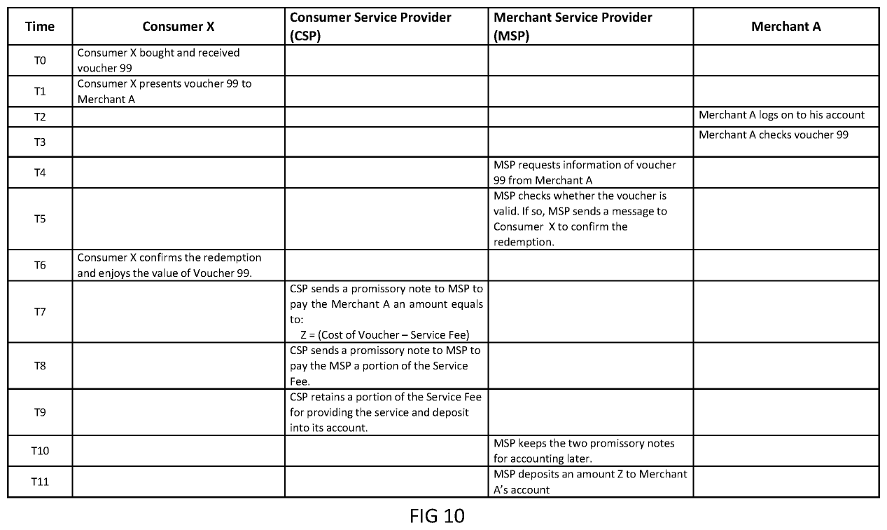

FIG. 10 illustrates an exemplary transaction process of redeeming a voucher. As depicted in the example of FIG. 10, when consumer X 701, 711 redeems a voucher from merchant A 703, 713: At time step T0, consume X 701, 711 bought the voucher 99 and received the blockchain as shown in FIG. 9B representing voucher 99. At time step T1, consumer X 701 or 711, via the electronic device associated with the consumer, sends voucher 99 to merchant A 703, 713 in the form of the received blockchain At time step T2, merchant A 703 or 713 logs into the merchant account. At time step T3, merchant A 703, 713 enters the voucher number or scans the voucher's QR code and sends the voucher information to merchant service provider server 704 or 714 that issues the voucher. At time step T5, merchant service provider server 704 or 714 verify whether the voucher or blockchain is valid by computing the hash values of all the blocks. If the computed hash value is the same as the corresponding hash values of the blockchain, for example, if the hash value transaction hash field 426 or 1126 of the blockchain is the same as the computed hash value of transaction hash field 426 or 1126 of the blockchain, the blockchain is valid. In some examples, additionally or alternatively, if the hash value in the transaction hash field 426 or 1126 of the sentinel block in the blockchain is the same as the hash value in the transaction hash field 426 or 1126 of the sentinel block saved at the central depository, the blockchain is valid, and the merchant service provider server 704 or 714 may proceed to a requested transaction in association with the blockchain. Therefore, the central depository 340, 540 or 733 provides additional validation of a blockchain with the sentinel block information stored therein. If any one of the computed hash values is different from the corresponding hash value in the blockchain, the blockchain will be rejected. For example, the blockchain is invalid, if the hash value transaction hash field 426 or 1126 of the sentinel block of the blockchain is different from the computed hash value of transaction hash field 426 or 1126 of the blockchain, if the hash value in the transaction hash field 426 or 1126 of the sentinel block in the blockchain is different from the hash value in the hash value of the transaction hash field 426 or 1126 of the sentinel block saved at the central depository. The requested transaction, such as redemption of the voucher represented in the blockchain, will be declined by the merchant service provider server 704 or 714. If blockchain 950 is valid, merchant service provider server 704 or 714 may send a message to the electronic device associated with consumer A 701, 711 to confirm that the consumer X may redeem the voucher. At time step T6, consumer 701 or 711 may confirm via the electronic device to merchant service provider server 704 or 714 to proceed with the redemption of the voucher via consumer service provider server 702 or 712.

As illustrated in FIG. 11, after the voucher 99 has been redeemed, merchant A 703 or 713 may insert a third block 480 immediately following the block 470 to the blockchain 1100 representing voucher 99. Previous hash 481 (Hash 4) is the transaction hash value 479 of the block 470 in the blockchain 1100. Fields 482-487 are transaction data fields including date and time 482, block number 483, block operation 484, voucher operation 485, consumer's name 486 and voucher value 487. Payload hash 488 (Hash 5) is the hash value of the transaction data content in the block namely date and time 482, block number 483, block operation 484, voucher operation 485, consumer's name 486 and voucher value 487. The value of the voucher is now set as zero dollar by merchant service provider server 704 or 714 because the voucher has been just entirely redeemed. In some examples, if the value of the voucher has been partially redeemed, for example only $80 is redeemed, the value of the voucher may be updated to $20 dollar by merchant service provider server 704 or 714. The remaining available voucher value may be redeemed by repeating the process illustrated in FIG. 10. Transaction hash 489 is the hash value of previous hash 481 and payload hash 488. The blockchain of the voucher is terminated by a new sentinel 1120 illustrated in FIG. 11. Previous hash 1121 is the transaction hash value 489 of the block 480 in the blockchain 1100. Payload hash 1125 is the hash value of the data content in the sentinel block 1120 namely block number 1123 and date and time 1124 of the previous block. In some examples, Payload hash 1125 may also include the hash value the sentinel marker 1122. Transaction hash 1126 is the hash value of previous hash 1121 and payload hash 1125. The hash value may be generated by SHA-256, as previous described.

At time step T7, consumer service provider server 702 or 712 may send a first message, such as a promissory note, to merchant service provider server 704 or 714 to pay merchant A 703, 713 an amount equals to: Z=(Cost of Voucher−Service Fee). At time step T8, consumer service provider server 702, 712 may send a second message, such as a promissory note, to merchant service provider 703, 713 to pay a small portion of the Service Fee for providing the mediating service for redemption. At time step T9, consumer service provider server 702, 712 also pays itself a portion of the Service Fee for providing the mediating service by deducting the corresponding amount from the transaction total. At time step T10, merchant service provider server 704 or 714 keeps the first and second messages, such as two transaction records, for accounting with the clearing house 731 later, as will be described below. At time step T11, merchant service provider server 704 and 714 deposits the amount Z to merchant 703, 713's account registered with the merchant service provider server 704, 714.

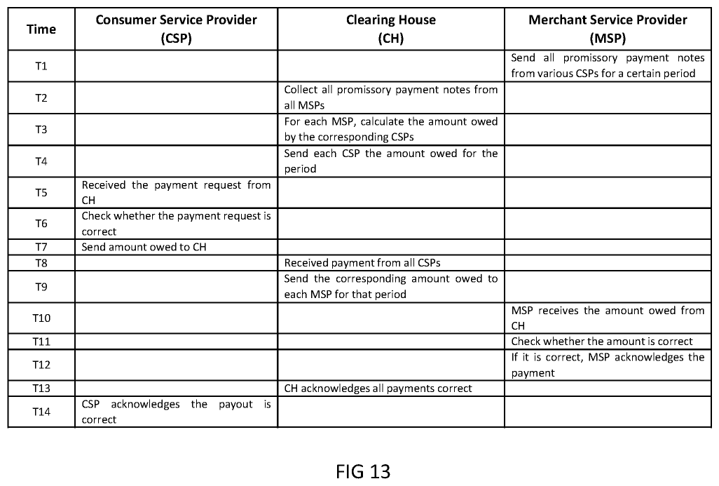

A clearing house 731 may be deployed in system 700 to reduce the number of direct contractual and data relationships between service providers. A clearing house 731, which may be one or more servers, receives, validates and transfers billing records and/or performs financial clearing functions between service providers 740, 710 that allow their consumers 701, 711 to use the Internet to pay their respective merchants 703, 713 online globally. The following described a transaction process, as depicted in FIG. 13 when clearing house 731 is used to settle payments between consumer service provider servers 702, 712 and merchant service provider servers 704, 714. At time step T1, merchants 703, 713 send all transaction records from various consumer service providers 702, 712 collected over a certain period. At time step T2, a clearing house 731, such as a server, may collect all payment related messages, such as transaction records, from all merchant service provider servers 704, 714. At time step T3, for each merchant service provider server 704, 714, calculate and sum all the amount owed by the corresponding consumer service providers 702, 712. At time step T4, a server of the clearing house 731 may send to each consumer service provider server 702, 712 the amount owed for the period. At time steps T5 and T6, each consumer service provider server 702, 712 receives the payment request from the server of the clearing house 731 and verify whether the payment request by the clearing house is correct. At time step T7, each consumer service provider server 702, 712 may send its amount owed to the server of clearing house 731. At time step T8, the server of clearing house 731 receives payments from all consumer service providers 702, 712. At time step T9, the server of clearing house 731 may send the corresponding amount owed to each merchant service provider server 704, 714 for that period. At time steps T10 and T11, each merchant service provider server 704, 714 receives the amount owed from clearing house 731 and checks whether the amount is correct. At time step T12, each merchant service provider server 704, 714 may acknowledges the payment from the server of clearing house 731 if the amount received is correct. At time step T13, clearing house 731 acknowledges all payments are correct and complete. At time step T14, each consumer service provider server 702, 712 acknowledges the payout process is complete.

As described above, in a transaction, lots of information may be exchanged among multiple independent parties or servers, namely consumers, consumer service providers, merchants, merchant service providers, and clearing house, or servers associated therewith, in a peer-to-peer fashion. Also, transaction records are generated and stored in consumer service provider servers 702, 712, merchant service provider servers 704, 714, and server of clearing house 731 in a distributed fashion. The most popular form of this tamper evident and tamper resistant semi-distributed digital ledger is the blockchain.

In some examples, merchants and consumers may logon to their respective accounts to view and download their own blockchains from the service provider servers 710 and 740 for safe private storage. They can also validate all the recorded transactions in the blockchains offline. Upon receiving the blockchain, the hash values of all the blocks may be computed and compared offline the computed transaction hash of the sentinel with the transaction hash of the sentinel, for example by application softwares. If the computed transaction hash of the sentinel is the same with the transaction hash of the sentinel, then the blockchain is valid.

Although the examples of transactions are described with respect to voucher transactions, the private blockchain described herein may be used to represent various transactions, including financial transactions and online payment. The contents of any transaction may be included in the transaction date field of one or more blocks of the private blockchain described herein and the validity of the blockchains may be verified by the sentinel block.

The above describes the first preferred embodiment of a system whereby the consumer service provider and merchant service provider of a regional service provider, the clearing house, sentinel depository are implemented as individual servers serving the respective consumers and merchants.

It is also possible to envision the second preferred embodiment of a system and method whereby the regional service providers, each has a server providing services to its consumers and merchants respectively. The clearing house and sentinel depository are implemented as individual servers serving the regional service providers.

It is also possible to envision the third preferred embodiment of a system and method whereby the consumer service provider and merchant service provider of a regional service provider, the clearing house, sentinel depository are implemented in one single server serving the respective consumers and merchants.

Certain adaptations and modifications of the described embodiments can be made. Therefore, the above discussed embodiments are considered to be illustrative and not restrictive. The above-described embodiments of the invention are intended to be examples, and alternatives and modifications to the embodiments may be made by those of skill in the art, without departing from the scope of the invention which is defined by the claims appended hereto.

In accordance with an example embodiment, there is provided a non-transitory computer-readable medium containing instructions executable by a processor for performing any one of or all of the described methods. In accordance with an example embodiment, there is provided a processor-implemented method for performing any one of or all of the described functions described with respect to any of the processors.

In accordance with an example embodiment, there is provided a non-transitory computer-readable medium containing instructions executable by a processor for performing any one of or all of the described methods. In accordance with an example embodiment, there is provided a processor-implemented method for performing any one of or all of the described functions described with respect to any of the processors.

In the described methods, the boxes may represent events, steps, functions, processes, modules, state-based operations, etc. While some of the above examples have been described as occurring in a particular order, it will be appreciated by persons skilled in the art that some of the steps or processes may be performed in a different order provided that the result of the changed order of any given step will not prevent or impair the occurrence of subsequent steps. Furthermore, some of the messages or steps described above may be removed or combined in other embodiments, and some of the messages or steps described above may be separated into a number of sub-messages or sub-steps in other embodiments. Even further, some or all of the steps may be repeated, as necessary. Elements described as methods or steps similarly apply to systems or subcomponents, and vice-versa. Reference to such words as “sending” or “receiving” could be interchanged depending on the perspective of the particular device.

While some example embodiments have been described, at least in part, in terms of methods, a person of ordinary skill in the art will understand that some example embodiments are also directed to the various components for performing at least some of the aspects and features of the described processes, be it by way of hardware components, software or any combination of the two, or in any other manner. Moreover, some example embodiments are also directed to a pre-recorded storage device or other similar computer-readable medium including program instructions stored thereon for performing the processes described herein. The computer-readable medium includes any non-transient storage medium, such as RAM, ROM, flash memory, compact discs, USB sticks, DVDs, HD-DVDs, or any other such computer-readable memory devices.

It will be understood that the electronic devices, computers, servers, workstations described herein include one or more processors and associated memory. The memory may include one or more application program, modules, or other programming constructs containing computer-executable instructions that, when executed by the one or more processors, implement the methods or processes described herein.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover all suitable changes in technology.

### INDUSTRIAL APPLICABILITY

The system and method is applicable internationally, since no national specific knowledge is required on the service providers which provides the service.

The invention relates to the system and method of a novel blockchain technology to provide incorruptible and verifiable data transaction. All transactions in the blockchain are protected by using sentinel and central depository.

Thus, the system and method described herein provides for managing the flow of transactional information using private blockchain. The system and method is applicable for online voucher sale (e.g. of prepaid accounts) as well as for offline billing (postpaid billing).

Embodiments described above relate to online voucher sale and redemption. It will be appreciated that the system and method is not limited to online voucher sale as described above, it may be more generally applied to other e-commerce services such as physical product sale or online services.

The above-described embodiments of the invention are intended to be examples, and alternatives and modifications to the embodiments may be made by those of skill in the art, without departing from the scope of the invention which is defined by the claims appended hereto.

1. A method for conducting a transaction using a private blockchain, comprising:
generating, by a processor, a first transaction block representing a first transaction in the private blockchain, the first transaction block comprising a first block header field, a first transaction data field containing first transactional information, a first payload hash field containing a first hash value of the transactional information, and a first transaction hash field containing a first hash value of a value contained in the first block header field and the first hash value contained in the first payload hash field;
generating, by the processor, a first sentinel block, the first sentinel block comprising a first previous hash field having an identical hash value as the first transaction hash field of the first transaction, a first sentinel marker field for uniquely identifying the first sentinel block in the private blockchain, a first transaction data field containing at least a portion of the transactional information in the first transaction data field of the first transactional block, a first payload hash field comprising a hash value of the transaction data field of the sentinel block, and a first transactional hash field containing a first hash value of the first previous hash field and the first payload hash field of the first sentinel block; and
appending, by the processor, the sentinel block to the transaction block of the private blockchain.

2. The method of claim 1, further comprising storing, by the processor, the private blockchain to a memory.

3. The method of claim 1, further comprising storing, by the processor, the first sentinel block a remote central depository.

4. The method of claim 1, further comprising storing, by the processor, the first hash value of the first transaction has field of the first sentinel block to a remote central depository.

5. The method of claim 1, wherein the transactional information includes a transaction amount and an identifier of the processor.

6. The method of claim 5, wherein the transactional information further includes one or more of a unique identifier of the transaction block in the private blockchain, and a description of the transaction.

7. The method of claim 1, wherein the first block header field contains a null value if the first transaction block is a first block of the private blockchain, and the first block header field contains a hash value of a transaction hash field of a block immediately preceding the first transaction block if the at least one block precedes the first transaction block.

8. The method of claim 1, wherein the first transaction is a voucher purchase from a merchant by a consumer.

9. The method of claim 1, further comprising transmitting, from the processor, the private blockchain to an electronic device associated with a consumer.

10. The method of claim 3, further comprising:
receiving, at the processor, the private blockchain from an electronic device associated with a consumer;
retrieving, by the processor, the first sentinel block corresponding to the private blockchain from the central depository; and
proceeding to a second transaction when the first transaction hash in the first sentinel block in the private blockchain is the same as the transaction hash in the first sentinel block saved in the central depository.

11. The method of claim 9, further comprising:
receiving, at the processor, the private blockchain from the electronic device;
identifying the first sentinel block from the private blockchain;
computing respective hash values of the first payload hash field of the first transaction block, the first transaction data hash field of the first transaction block, the first previous hash field of the first sentinel block, the first payload hash field of the first sentinel block, and the transaction data hash field of the sentinel block; and
validating the private blockchain, by the processor, when computed respective hash values are the same as the respective hash values in the first transaction block and the first sentinel block.

12. The method of claim 11, further comprising: proceeding, by the processor, to a second transaction after the private blockchain has been validated.

13. The method of claim 12, further comprising:
removing the first sentinel block from the private blockchain;
generating, by the processor, a second transaction block representing the second transaction, wherein the second transaction block comprising a second block header field comprising a hash value of the transaction hash field of the first transaction block, a second transaction data field containing transactional information of the second transaction, a second payload hash field containing a hash value of the transactional information of the second transaction, and a second transaction data hash field containing a hash value of a value contained in the second block header field and the hash value contained in the second payload hash field;
appending, by the processor, the second transaction block to the first transaction block;
generating, by the processor, a second sentinel block, the second sentinel block comprising a second previous hash field having an identical hash value as the second transaction hash field, a second sentinel marker field for uniquely identifying the second sentinel block in the private blockchain, a second transaction data field containing at least a portion of the transactional information in the transaction data field of the second transactional block, a second payload hash field comprising a hash value of the second transaction data field of the second sentinel block, and a second transactional hash field containing a hash value of the second previous hash field and the payload hash field; and
appending, by the processor, the second sentinel block to the second transaction block of the private blockchain.

14. The method of claim 13, wherein the second transaction is a voucher redemption.

15. The method of claim 13, further comprising storing, by the processor, the second sentinel block or the second transaction hash of the second sentinel block to the remote memory.

16. A system for conducting a transaction using a private blockchain, comprising:
one or more service provider servers configured to communicate with each other;
each service provider server comprising a processor and a memory; and
the processor is configured to:
receive, at the processor, a request to conduct a first transaction;
in response, generate, by a processor, a first transaction block representing a first transaction in the private blockchain, the first transaction block comprising a first block header field, a first transaction data field containing first transactional information, a first payload hash field containing a first hash value of the transactional information, and a first transaction hash field containing a first hash value of a value contained in the first block header field and the first hash value contained in the first payload hash field;
generate, by the processor, a first sentinel block, the first sentinel block comprising a first previous hash field having an identical hash value as the first transaction hash field of the first transaction, a first sentinel marker field for uniquely identifying the first sentinel block in the private blockchain, a first transaction data field containing at least a portion of the transactional information in the first transaction data field of the first transactional block, a first payload hash field comprising a hash value of the transaction data field of the sentinel block, and a first transaction hash field containing a first hash value of the first previous hash field and the first payload hash field of the first sentinel block; and
append, by the processor, the first sentinel block to the transaction block of the private blockchain.

17. The transaction system of claim 16, further comprising a remote central depository to communicate with the one or more service provider servers, wherein the remote central depository is configured to store the first sentinel block or the first transaction hash value of the first transaction hash field of the first sentinel block received from the processor.

18. The transaction system of claim 17, further comprising a communication network for the one or more service provider servers and the remote central depository to communicate with each other.

19. The transaction system of claim 17, wherein the processor is configured to retrieve from the remote central depository stored first sentinel block or the first transaction hash value of the first transaction hash field of the first sentinel block.

20. A non-transitory computer-readable medium containing instructions executable by a processor, the instructions configured to, when executed, cause the processor to:
receive, at the processor, a request to conduct a first transaction;
in response, generate, by the processor, a first transaction block representing a first transaction in a private blockchain, the first transaction block comprising a first block header field, a first transaction data field containing first transactional information, a first payload hash field containing a first hash value of the transactional information, and a first transaction hash field containing a first hash value of a value contained in the first block header field and the first hash value contained in the first payload hash field;
generate, by the processor, a first sentinel block, the first sentinel block comprising a first previous hash field having an identical hash value as the first transaction hash field of the first transaction, a first sentinel marker field for uniquely identifying the first sentinel block in the private blockchain, a first transaction data field containing at least a portion of the transactional information in the first transaction data field of the first transactional block, a first payload hash field comprising a hash value of the transaction data field of the sentinel block, and a first transaction hash field containing a first hash value of the first previous hash field and the first payload hash field of the first sentinel block; and
append, by the processor, the first sentinel block to the transaction block of the private blockchain.
